(19) United States
(12) Patent Application Publication
(10) Pub. No.: US 2023/0382095 A1
(43) Pub. Date: Nov. 30, 2023

(54) METHOD FOR OBTAINING A LAMINATED BENT GLAZING

(71) Applicant: SAINT-GOBAIN GLASS FRANCE, COURBEVOIE (FR)

(72) Inventors: Juliette JAMART, COMPIEGNE (FR); Florian FLAMARY-MESPOULIE, COMPIEGNE (FR)

(21) Appl. No.: 18/245,919

(22) PCT Filed: Sep. 16, 2021
(86) PCT No.: PCT/FR2021/051590

§ 371 Date: Mar. 20, 2023

(30) Foreign Application Priority Data
Sep. 21, 2020 (FR) FR2009548

(51) Int. Cl. B32B 37/18; B32B 38/18; B32B 38/10; B32B 37/02; B32B 17/10

(52) U.S. Cl. CPC B32B 37/182; B32B 38/1808; B32B 38/10; B32B 37/02; B32B 17/10275; B32B 17/10761; B32B 2307/4023; B32B 2307/202; B32B 2307/41; B32B 2605/00

(57) ABSTRACT

A method for obtaining a laminated bent glazing, particularly for a motor vehicle windscreen or roof includes (b) depositing, on a part of the surface of a stack of thin layers deposited on a first glass sheet, in a zone referred to as zone to be demarginated, a washable dissolving layer, a pre-firing at the end of which the stack of thin layers located under the washable dissolving layer is dissolved by the washable dissolving layer, creating a demarginated zone, eliminating (d) the washable dissolving layer by washing, bending (e) the first glass sheet and an additional glass sheet, together or separately, laminating (g) the first glass sheet with an additional glass sheet by a lamination interlayer having an opaque zone arranged facing the demarginated zone.

The invention relates to the field of laminated bent glazings for motor vehicles, for examples for roofs or windscreens, comprising a glass sheet coated with a stack of thin layers.

Laminated glazings are glazings in which two glass sheets are adhesively bonded by means of a lamination interlayer. The latter makes it possible in particular to retain shards of glass in the event of breakage, but also provides other functions, in particular in terms of resistance to breaking and entering or improving acoustic properties.

These glazings conventionally comprise an opaque zone, generally black, often deposited in the form of a peripheral strip intended to hide, and protect from ultraviolet radiation, the polymer seals that serve to attach and position the glazing in the vehicle body window opening. Opaque zones also hide the zones for attaching the interior rear-view mirror and various connectors and sensors.

These opaque zones are often obtained by depositing layers of enamel. In a laminated glazing, these layers of enamel are generally arranged on face 2, with the faces traditionally being numbered starting from the face intended to be positioned on the outside of the vehicle. Face 2 is therefore a face which is in contact with the lamination interlayer. Enamel is generally obtained by firing a composition comprising a glass frit and pigments at above 500° C. A glass frit is composed of fine particles of glass with a low melting point which, under the effect of a firing heat treatment, softens and adheres to the glass sheet. This thus forms a generally opaque mineral layer with high chemical and mechanical resistance, which adheres perfectly to the glass, holding the pigment particles. The firing step is generally carried out simultaneously with the bending of the glass sheet.

In the context of manufacturing laminated glazings, the two glass sheets of the glazing are often bent together, with the glass sheet intended to be positioned on the inside of the vehicle generally being arranged above the other glass sheet, which carries the enamel. It is then necessary for the enamel to have non-stick properties in order to prevent any bonding between the two glass sheets during the bending. To this end, enamels containing bismuth are usually employed, i.e. enamels obtained from glass frits containing bismuth oxide.

Coatings, generally in the form of stacks of thin layers, can also be present on one of the glass sheets of the laminated glazing. These may particularly be electrically conductive layers, which can provide two types of functions. Firstly, when current supplies are provided, electrically conductive layers can dissipate heat by the Joule effect. These are then heating layers, of use for example for defrosting or defogging. Secondly, due to their reflection of infrared radiation, these layers have solar control or low-emissivity properties. The layers are thus valued for the improvement in thermal comfort or for the energy savings they provide, by reducing the consumption intended for heating or air conditioning. These stacks of layers are generally arranged on face 3 of the laminated glazing, therefore also in contact with the lamination interlayer.

Nevertheless, in some cases which will be described in detail hereinafter, it may be beneficial to have the enamel layer and the stack of thin layers on the same glass sheet, and therefore on the same face of the glass sheet in question, in order for these coatings to be protected inside the laminated glazing.

However, it has been observed that, when a glass sheet coated with a stack of thin layers had to be provided with an enamel layer, unwanted interactions may occur between the stack and the enamel during the bending, leading particularly to a degradation of the aesthetic appearance of the enamel. It has been observed, in particular when the stack contains at least one nitride layer and the enamel contains bismuth, that bubbles were formed within the enamel, close to the interface between the latter and the stack, causing a significant lowering of the adhesion of the enamel, altering the optical appearance thereof (in particular the color on the glass side, i.e. on the side opposite the enamel) and reducing the chemical resistance thereof, in particular to acids.

The aesthetic appearance of the opaque zone, viewed from the outside of the vehicle, holds particular importance for car manufacturers. However, the aforementioned interactions lead to an undesirable grayish hue.

Several solutions to this problem have been proposed.

It is possible to remove beforehand the stack of thin layers at the locations where the enamel layer is to be deposited, for example by means of abrasives, in order for the enamel to be deposited in direct contact with the glass sheet and to prevent any problems of interaction between the enamel layer and the stack of thin layers. However, this demargination by mechanical abrasion produces visible scratches, including on the enamel layer.

Application WO 2014/133929, and before it application WO0029346, proposed the concept of using, for the enamel, special glass frits which, during firing or pre-firing, are capable of dissolving the stack of thin layers in order to become directly attached to the glass. However, such enamels do not have good non-stick properties, causing the two glass sheets to bond together during bending.

Application WO 2019/106264 proposes modifying the stack of thin layers by adding a layer of oxide between the stack and the enamel comprising bismuth. However, it is not always possible to make such a change.

The invention aims to overcome these shortcomings by proposing another way to obtain a laminated glazing comprising a stack of thin layers and an opaque zone having the desired reflective appearance.

To this end, the invention relates to a method for obtaining a laminated bent glazing, particularly for a motor vehicle windscreen or roof, comprising the following steps:
a. providing a first glass sheet, coated on at least part of one of the faces thereof with a stack of thin layers,
b. a step of depositing, on a part of the surface of the stack of thin layers, in a zone referred to as “zone to be demarginated”, a washable dissolving layer,
c. a pre-firing step at the end of which the stack of thin layers located under the washable dissolving layer is dissolved by said washable dissolving layer,
d. a step of eliminating the washable dissolving layer by washing, creating a demarginated zone,
e. a step of bending the first glass sheet and an additional glass sheet, together or separately,
f. a step of providing a lamination interlayer comprising an opaque zone,
g. a step of laminating said first glass sheet with the additional glass sheet by means of the lamination interlayer so that the opaque zone of said lamination interlayer is arranged facing the demarginated zone and the stack of thin layers faces the lamination interlayer.

The invention also relates to a laminated bent glazing, particularly for a motor vehicle windscreen or roof, obtained or likely to be obtained by this method.

Replacing the enamel with an opaque zone formed on the lamination interlayer makes it possible to avoid the aforementioned unwanted interactions. The suppression of the stack of thin layers in relation to this opaque zone makes it possible to ensure a perfect appearance. In the context of the present invention, the adjective “opaque” is understood to be associated with visible radiation.

Step a

The first glass sheet may be flat or bent. The first glass sheet is generally flat during the deposition of the stack of thin layers followed by the washable dissolving layer, and is then bent during step e. The first glass sheet is thus bent in the bent laminated glazing according to the invention.

The glass of the first glass sheet is typically a soda-lime-silica glass, but other glasses, for example borosilicates or aluminosilicates, can also be used. The first glass sheet is preferably obtained by the float method, i.e. by a method consisting in casting molten glass onto a bath of molten tin.

The first glass sheet may be made of clear glass or tinted glass, preferably of tinted glass, for example green, gray or blue. To this end, the chemical composition of the first glass sheet advantageously comprises iron oxide, in a content by weight ranging from 0.5 to 2%. It may also comprise other coloring agents, such as cobalt oxide, chromium oxide, nickel oxide, erbium oxide or else selenium.

The first glass sheet preferably has a thickness within a range extending from 0.7 to 19 mm, particularly from 1 to 10 mm, in particular from 2 to 6 mm, or even from 2 to 4 mm.

The lateral dimensions of the first glass sheet (and of the additional glass sheet) should be adapted based on those of the laminated glazing with which it is intended to be integrated. The first glass sheet (and/or the additional glass sheet) preferably has a surface area of at least 1 m².

During step a, the first glass sheet is preferably coated with the stack of thin layers over at least 70%, particularly over at least 90%, or even over the entire surface of the face of the glass sheet. Indeed, some zones may not be coated in order particularly to provide communicating windows that allow waves to pass.

The stack of thin layers is preferably in contact with the glass sheet. During its deposition, the washable dissolving layer is preferably in contact with the stack of thin layers.

In the present text, “contact” is intended to mean physical contact. The expression “based on” is preferably intended to mean the fact that the layer in question comprises at least 50% by weight of the material in question, particularly 60%, or even 70% and even 80% or 90%. The layer may even substantially consist of, or consist of, this material. “Essentially consist of” should be understood to mean that the layer may comprise impurities which have no influence on its properties. The terms “oxide” or “nitride” do not necessarily mean that the oxides or nitrides are stoichiometric. Indeed, they may be substoichiometric, superstoichiometric or stoichiometric.

The stack preferably comprises at least one layer based on a nitride. The nitride is particularly a nitride of at least one element selected from aluminum, silicon, zirconium, titanium. It may comprise a nitride of at least two or three of these elements, for example a silicon zirconium nitride or a silicon aluminum nitride. The layer based on a nitride is preferably a layer based on silicon nitride, more particularly a layer consisting essentially of a silicon nitride. When the layer of silicon nitride is deposited by cathode sputtering, it generally contains aluminum because it is common practice to dope silicon targets with aluminum in order to accelerate the deposition rates.

The layer based on a nitride preferably has a physical thickness in a range extending from 2 to 100 nm, particularly from 5 to 80 nm.

The layers based on nitride are commonly used in a large number of stacks of thin layers since they have advantageous blocking properties, in that they prevent the oxidation of other layers present in the stack, particularly functional layers which will be described below.

The stack preferably comprises at least one functional layer, particularly an electrically conductive functional layer. The functional layer is preferably included between two thin dielectric layers, at least one of which is a layer based on nitride. Other possible dielectric layers are for example layers of oxides or oxynitrides.

At least one electrically conductive functional layer is advantageously selected from:
metal layers, particularly made of silver or niobium, or even gold, and
layers of a transparent conductive oxide, particularly selected from indium tin oxide, doped tin oxides (for example doped with fluorine or antimony), doped zinc oxides (for example doped with aluminum or gallium).

These layers are particularly valued for their low emissivity, which gives the glazings excellent thermal insulation properties. In glazings equipping land vehicles, particularly motor vehicles, rail vehicles, or else aircraft or marine vessels, low-emissivity glazings make it possible, in hot weather, to outwardly reflect part of the solar radiation, and therefore to limit the heating of the passenger compartment of said vehicles, and where appropriate to reduce air-conditioning costs. Conversely, in cold weather, these glazings make it possible to retain the heat within the passenger compartment, and consequently to reduce the heating energy required.

According to a preferred embodiment, the stack of thin layers comprises at least one layer of silver, particularly one, two, three, or even four layers of silver. The physical thickness of the layer of silver or, where appropriate, the sum of the thickness of the layers of silver, is preferably between 2 and 20 nm, particularly between 3 and 15 nm.

According to another preferred embodiment, the stack of thin layers comprises at least one layer of indium tin oxide. The physical thickness thereof is preferably between 30 and 200 nm, particularly between 40 and 150 nm.

In order to protect the or each electrically conductive thin layer (whether metal or based on transparent conductive oxide) during the bending step, each of these layers is preferably surrounded by at least two dielectric layers. The dielectric layers are preferably based on oxide, nitride and/or oxynitride of at least one element selected from silicon, aluminum, titanium, zinc, zirconium, tin.

At least part of the stack of thin layers can be deposited by various known techniques, for example chemical vapor deposition (CVD), or by cathode sputtering, particularly magnetic-field-assisted (magnetron method).

The stack of thin layers is preferably deposited by cathode sputtering, particularly magnetron sputtering. In this method, a plasma is created in a high vacuum close to a target comprising the chemical elements to be deposited. By bombarding the target, the active species of the plasma tear off said elements, which are deposited on the glass sheet, forming the desired thin layer. This method is called a “reactive” method when the layer is made of a material resulting from a chemical reaction between the elements torn off from the target and the gas contained in the plasma. The major advantage of this method lies in the possibility of depositing a very complex stack of layers on the same line by making the glass sheet run in succession beneath various targets, generally in the same device.

The abovementioned examples have properties of electrical conduction and infrared reflection which are of use for providing a heating function (defrosting, defogging) and/or a thermal insulation function.

When the stack of thin layers is intended to provide a heating function, supplies of current must be provided. This may particularly be strips of silver paste deposited by screen printing on the stack of thin layers, at two opposite edges of the glass sheet. These strips are hidden by the opaque zone in the final glazing.

Step b

The stack is preferably coated with the washable dissolving layer over 2 to 25%, particularly 3 to 20%, or even 5 to 15% of the surface thereof. The area to be demarginated (and at the end the demarginated zone) preferably forms a peripheral strip, i.e. a strip closed onto itself which, at any point of the periphery of the first glass sheet, extends toward the inside of the first glass sheet over a certain width, typically of between 1 and 20 cm. The width can vary according to the location of the point in question.

During step b, the washable dissolving layer is preferably deposited from a fluid composition, particularly liquid or paste-like. The washable dissolving layer is preferably deposited by screen printing. To this end, a screen-printing screen is placed on the glass sheet, which screen comprises mesh apertures, some of which are blocked off, then the fluid composition is deposited on the screen, then a squeegee is applied in order to force the fluid composition through the screen in the zones where the screen apertures have not been blocked off, so as to form a washable dissolving layer.

The thickness of the washable dissolving layer is preferably between 5 and 50 μm, particularly between 10 and 40 μm, or even between 15 and 30 μm.

Step b is preferably immediately followed by a drying step, intended to eliminate at least part of the solvent contained in the fluid composition. Such drying is typically performed at a temperature comprised between 120 and 180° C.

The washable dissolving layer is preferably a mineral layer comprising at least one phosphate. The phosphate is particularly an alkaline phosphate, preferably a sodium phosphate. The term “phosphate” is also intended to mean the hydrogen phosphates and the dihydrogen phosphates. The generic term sodium phosphate therefore also covers sodium hydrogen phosphate Na₂HPO₄, sodium dihydrogen phosphate NaH₂PO₄, and trisodium phosphate Na₃PO₄, as well as the mixtures of these compounds.

The fluid composition preferably comprises a solvent, particularly organic, and a resin. The amounts of solvent and resin make it possible to adjust the viscosity of the composition, and should be adapted based on the application method used.

Step c

The pre-firing step is preferably carried out at a temperature comprised between 150 and 700° C., particularly between 550 and 700° C.

Such pre-firing makes it possible to eliminate the organic medium, or typically any organic component that may be present in the washable dissolving layer.

During the pre-firing, the stack of thin layers is dissolved by the washable dissolving layer. The dissolution of the stack can be observed under electron microscopy.

Step d

The step of eliminating the washable dissolving layer makes it possible to eliminate the latter by virtue of washing.

to In the demarginated zone, the surface of the glass is thus bare, since it is no longer coated, either by the stack of thin layers or by the washable dissolving layer.

The washing is preferably carried out by spraying pressurized water or by means of a washing machine provided with brushes. The brushes must be flexible so as to avoid damaging the stack of thin layers.

Step e

Bending can be carried out using gravity (the glass deforms under its own weight) or by pressing, at temperatures typically ranging from 550 to 650° C.

According to a first embodiment, the two glass sheets (first glass sheet and additional glass sheet) are bent separately.

According to a second embodiment, the first glass sheet and the additional glass sheet are bent together. The glass sheets can be kept at a distance by arranging therebetween an interlayer powder ensuring a space of several tens of micrometers, typically of 20 to 50 μm. The interlayer powder is for example based on calcium and/or magnesium carbonate. During the bending, the interior glass sheet (intended to be positioned inside the passenger compartment) is normally placed above the exterior glass sheet. Thus, during the bending step, the additional glass sheet is generally placed above the first glass sheet.

Step f

The lamination interlayer preferably comprises at least one sheet of polyvinyl acetal, particularly polyvinyl butyral (PVB).

The lamination interlayer can be tinted or untinted in order, if necessary, to regulate the optical or thermal properties of the glazing.

The lamination interlayer may advantageously have acoustic absorption properties in order to absorb airborne or structure-borne sounds. To this end, it may particularly consist of three polymeric sheets, including two “external” PVB sheets surrounding an internal polymeric sheet, optionally made of PVB, with a lower hardness than that of the outer sheets.

The lamination interlayer may also have thermal insulation properties, in particular properties of infrared radiation reflection. To this end, it may comprise a coating of thin layers with low-emissivity, for example a coating comprising a thin layer of silver or a coating alternating dielectric layers with different refractive indices, deposited on an internal PET sheet surrounded by two external PVB sheets.

The thickness of the lamination interlayer is generally within a range extending from 0.3 to 1.5 mm, particularly from 0.5 to 1 mm. The lamination interlayer can have a smaller thickness on an edge of the glazing than at the center of the glazing in order to prevent the formation of a double image in the case of using a head-up display (HUD).

The lamination interlayer comprises an opaque zone, the rest forming a transparent zone. The opaque zone preferably represents 2 to 25%, particularly 3 to 20%, or 5 to 15% of the surface of the lamination interlayer (the surface to be taken into account being the surface in the final glazing). The opaque zone preferably forms a black, opaque strip, at the periphery of said lamination interlayer. The shape of this strip substantially matches the shape of the demarginated zone located on the first glass sheet. The demarginated zone then forms a strip at the periphery of the first glass sheet.

The opaque zone of the lamination interlayer is preferably obtained by depositing a layer of ink. The ink preferably comprises a resin as well as black pigments. The resin is particularly chosen among polyvinyl butyral, ethylene and vinyl acetate copolymers, polyurethanes and epoxy resins. The resin is preferably a polyvinyl butyral, particularly with a molecular weight between 10,000 and 50,000. An appropriate ink is for example described in application EP2697318. The ink can particularly be deposited by screen printing on the lamination interlayer. The wet ink thickness is preferably comprised between 5 and 50 μm. The layer of ink can be arranged on one side or the other of the lamination interlayer. When the latter consists of several layers, the layer of ink can also be disposed between two layers of the lamination interlayer.

According to another variant, the opaque zone of the lamination interlayer is obtained by coloring the interlayer in its body.

According to yet another variant, the opaque zone of the interlayer is obtained by attaching a sheet of opaque polymer to the interlayer. The attachment can be carried out particularly by electrostatic attraction.

Step d

The step of lamination may be carried out by treatment in an autoclave, for example at temperatures from 110 to 160° C. and under a pressure ranging from 10 to 15 bar. Prior to the autoclave treatment, the air trapped between the glass sheets and the lamination interlayer can be eliminated by calendering or by applying negative pressure.

The additional glass sheet is preferably the internal sheet of the laminated glazing, i.e. the sheet located on the concave side of the glazing, intended to be positioned inside the passenger compartment of the vehicle. Thus, the stack of thin layers is arranged on face 2 of the laminated glazing.

The opaque zone of the lamination interlayer is arranged facing the demarginated zone of the first glass sheet. Thus, in the final glazing, the opaque zone is arranged at the same level as the zone in which the stack of layers has been eliminated, which makes it possible to reach the desired values of opacity and appearance. These two zones may not perfectly and exactly match one another, due to the dimensional tolerances in terms of the positioning of the lamination interlayer and to the creep of the material that constitutes the interlayer during the lamination. There may therefore be a slight overlap between the opaque zone and zones coated by the stack, or conversely a bare glass space between the opaque zone and the demarginated zone. The overlap, or the bare glass space is preferably less than 1 mm, particularly than 0.5 mm.

In order to make less noticeable any aesthetic defects due to these relative positions that do not exactly match, a decoration, for example based on dots—such as a gradation of dots—can be printed in this area.

According to one embodiment, the layer of ink is facing the first glass sheet.

According to another embodiment, the layer of ink is facing the additional glass sheet. It was observed that the aforementioned possible defects associated with the relative positions of the demarginated zone and the opaque zone were less visible in this arrangement.

The additional glass sheet may be made of soda-lime-silica glass or else of borosilicate or aluminosilicate glass. It may be made of clear or tinted glass. Its thickness is preferably between 0.5 and 4 mm, particularly between 1 and 3 mm.

According to a preferred embodiment, the additional glass sheet has a thickness of between 0.5 and 1.2 mm. The additional glass sheet is particularly made of sodium aluminosilicate, preferably chemically reinforced. The additional glass sheet is preferably the interior sheet of the laminated glazing. The invention is particularly useful for this type of configuration for which it is difficult to arrange the stack of thin layers on face 3. The chemical reinforcement (also referred to as “ion exchange”) consists in bringing the surface of the glass into contact with a molten potassium salt (for example potassium nitrate) so as to reinforce the surface of the glass by exchanging ions of the glass (in this case sodium ions) with ions having a larger ionic radius (in this case potassium ions). This ion exchange makes it possible to form compressive stresses at the surface of the glass and over a certain thickness. Preferably, the surface stress is at least 300 MPa, particularly 400 and even 500 MPa, and at most 700 MPa, and the thickness of the zone under compression is at least 20 μm, typically between 20 and 50 μm. The stress profile can be determined in a known way using a polarizing microscope fitted with a Babinet compensator. The chemical tempering step is preferably carried out at a temperature ranging from 380 to 550° C., and for a duration ranging from 30 minutes to 3 hours. The chemical reinforcement is preferably carried out after the bending step but before the lamination step. The glazing obtained is preferably a motor vehicle windscreen, in particular a heating windscreen.

According to another preferred embodiment, the additional glass sheet carries, on the face opposite the face which is facing the lamination interlayer (preferably face 4, the additional sheet being the interior sheet), an additional stack of thin layers, particularly a low-emissivity stack, comprising a transparent conductive oxide, particularly indium tin oxide (ITO). The invention is also particularly useful for this type of configuration for which it is tricky to arrange the stacks of thin layers on both faces of the same glass sheet (face 3 and 4). In this embodiment, the lamination interlayer and/or the additional glass sheet is preferably tinted, the glass sheet carrying the coatings being able to be made of clear glass. The glazing obtained is preferably a motor vehicle roof.

As an example of the latter preferred embodiment, mention may be made of a laminated bent roof comprising, from the outside of the vehicle, a clear glass sheet coated on face 2 with a stack of thin layers comprising at least one silver layer, a lamination interlayer made of tinted PVB comprising an opaque zone, and an additional glass sheet made of tinted glass, carrying, on face 4, a low-emissivity stack of thin layers, particularly based on ITO.

### EXAMPLES

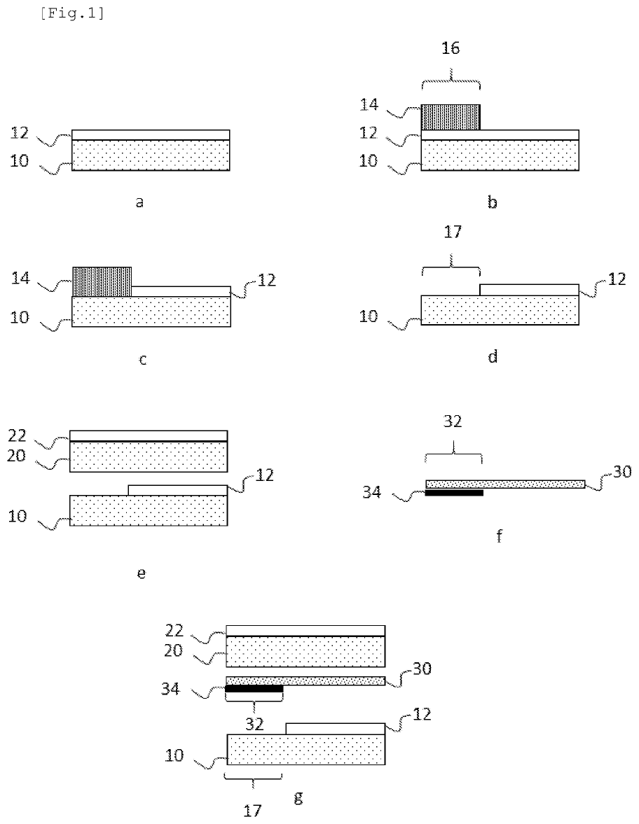

The following exemplary embodiments illustrate the invention in a non-limiting manner, in connection with FIGS. 1 to 6, wherein:

FIG. 1 schematically illustrates one embodiment of the method according to the invention.

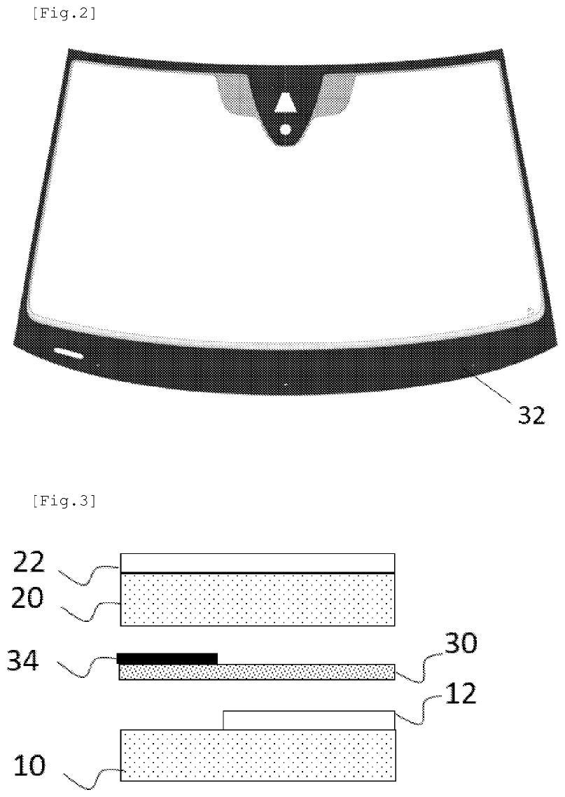

FIG. 2 illustrates one example of a glazing obtained according to the invention.

FIG. 3 schematically illustrates another embodiment of the method according to the invention.

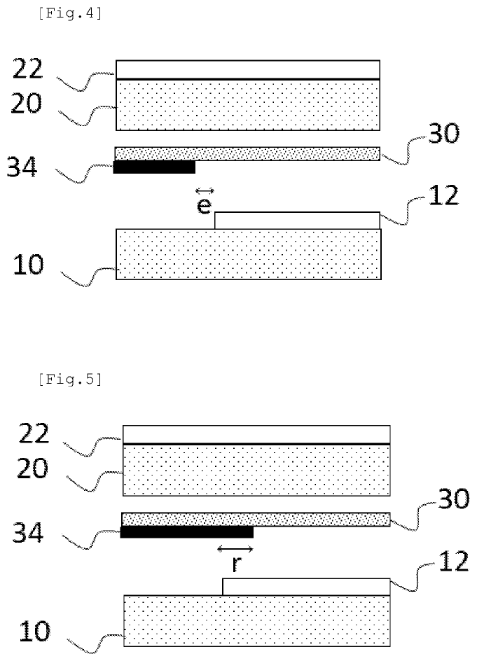

FIG. 4 schematically illustrates another embodiment of the method according to the invention.

FIG. 5 schematically illustrates another embodiment of the method according to the invention.

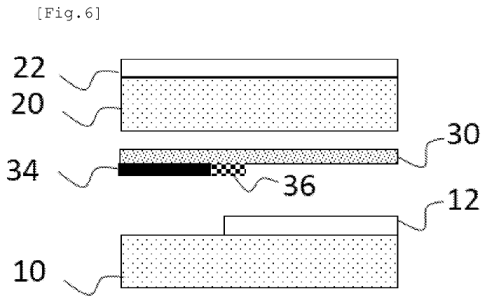

FIG. 6 schematically illustrates another embodiment of the method according to the invention.

FIGS. 1 and 3 to 6 depict a schematic cross-section of part of the glass sheets and elements deposited on the glass sheets, near the periphery of the latter, during the steps of the method. The various elements are obviously not depicted to scale, so as to be able to visualize them.

The first glass sheet 10 coated with the stack of thin layers 12 is provided in step a, then a part of the stack 12 is coated by a washable dissolving layer 14, particularly by screen printing (step b), in a zone 16 referred to as “zone to be demarginated”, intended to be placed substantially at an opaque zone in the final glazing.

In step c, the first glass sheet undergoes a pre-firing treatment leading in the zone 16 to a dissolution of the stack 12 by the washable dissolving layer 14. After washing (step d), which results in the elimination of the washable dissolving layer 14, the first glass sheet 10 has a bare glass surface in the demarginated zone 17.

An additional glass sheet 20, herein provided with an additional stack of thin layers 22, is then placed on the first glass sheet 10, and the whole is then bent (step e). Since the depicted view only shows the end of the glass sheet, the bending is not depicted herein.

In step f, a lamination interlayer 30 is provided. This interlayer 30 has an opaque zone 32 in the form of a layer of ink 34.

In step g, the first glass sheet 10 coated with the stack of thin layers 12 and the additional glass sheet 20 coated with the additional stack 22 are assembled by means of the lamination interlayer 30. The diagram herein depicts each of the separate elements, in exploded view. The stack 12, facing the lamination interlayer, is positioned in the final glazing on face 2. The opaque zone 32 is positioned facing the zone 16. In the embodiment depicted in FIG. 1, the layer of ink 34 faces the first glass sheet 10, thus face 2 of the final glazing.

FIG. 2 depicts an example of glazing according to the invention, in this case a windscreen. The opaque zone 32 is presented in the form of a peripheral strip whose width depends on its position on the glazing. The strip herein has a small width in the side zones, a large width in the lower zone, and a variable width in the upper zone, the opaque strip hiding in the central upper zone the means for positioning the central rear-view mirror and providing in this zone transmission windows for sensors and cameras, such as rain or light sensors or driving-assistance cameras or even lidars.

FIGS. 3 to 6 illustrate configurations other than FIG. 1. In the embodiment of FIG. 3, the layer of ink 34 faces the additional glass sheet 20. In the embodiments of FIGS. 4 to 6, the opaque zone of the lamination interlayer does not exactly match the demarginated zone of the first glass sheet. In FIG. 4, there is a slight space e between the two zones, typically of at most 1 mm, or even of at most 0.5 mm. In FIG. 5 conversely, an overlap r (or covering) is provided. In FIG. 6, this overlap is made less visible by virtue of a gradation of dots 36 obtained during the screen printing of the ink. As previously indicated, a possible overlap is also made less visible when the layer of ink faces the additional glass sheet (thus faces face 3 in the illustrated example).

The method carried out by the example corresponds to the embodiment of FIG. 1.

A glass sheet 2.1 mm thick, coated beforehand by cathode sputtering of a stack of thin layers comprising two silver layers protected by zinc oxide layers, silicon nitride layers and NiCr blockers, was coated, on a peripheral strip, by screen printing of a washable dissolving layer with a wet thickness of 25 μm. The deposited composition was a sodium phosphate based paste marketed by the company Ferro with reference TDF9283.

After drying (between 100 and 250° C., 1 to 2 minutes) a step of pre-firing at about 600° C. allowed the washable dissolving layer to dissolve the stack of thin layers. A washing step then made it possible to eliminate the washable dissolving layer.

After pairing with an additional glass sheet of soda-lime-silica glass with

a stack comprising a layer of ITO on face 4, the whole was bent at over 600° C. during 350 to 500 seconds. The two glass sheets were laminated together by means of a PVB interlayer, coated in a peripheral area with a black, screen-printed ink.

After assembly, the appearance, more particularly the black color viewed from face 1, was assessed by measuring the lightness L* in reflection (illuminant D65, reference observer 10°). The measured value of L* was in the range between 2 and 3.

1. A method for obtaining a laminated bent glazing, comprising:
a. providing a first glass sheet, coated on at least part of one of the faces thereof with a stack of thin layers,
b. depositing, on a part of a surface of the stack of thin layers, in a zone to be demarginated, a washable dissolving layer,
c. pre-firing the first glass sheet coated with the washable dissolving layer at the end of which the stack of thin layers located under the washable dissolving layer is dissolved by said washable dissolving layer,
d. eliminating the washable dissolving layer by washing, creating a demarginated zone,
e. bending the first glass sheet and an additional glass sheet, together or separately,
f. providing a lamination interlayer comprising an opaque zone, and
g. laminating said first glass sheet with the additional glass sheet by the lamination interlayer so that the opaque zone of said lamination interlayer is arranged facing the demarginated zone and the stack of thin layers faces the lamination interlayer.

2. The method according to claim 1, wherein the stack of thin layers comprises at least one functional layer.

3. The method according to claim 1, wherein the washable dissolving layer is a mineral layer comprising at least one phosphate.

4. The method according to claim 1, wherein the washable dissolving layer is deposited by screen printing.

5. The method according to claim 1, wherein a thickness of the washable dissolving layer is between 5 and 50 μm.

6. The method according to claim 1, wherein the demarginated zone forms a strip at a periphery of the first glass sheet and the opaque zone of the lamination interlayer forms a black, opaque strip at a periphery of said lamination interlayer.

7. The method according to claim 1, wherein the lamination interlayer comprises at least one sheet of polyvinyl acetal.

8. The method according to claim 1, wherein the opaque zone of the lamination interlayer is obtained by depositing a layer of ink.

9. The method according to claim 8, wherein the layer of ink comprises a resin and black pigments, the resin being selected from polyvinyl butyral, ethylene and vinyl acetate copolymers, polyurethanes and epoxy resins.

10. The method according to claim 8, wherein the layer of ink is facing the first glass sheet.

11. The method according to claim 8, wherein the layer of ink is facing the additional glass sheet.

12. The method according to claim 1, wherein the opaque zone of the lamination interlayer is obtained by coloring the interlayer in its body.

13. The method according to claim 1, wherein the opaque zone of the interlayer is obtained by attaching a sheet of an opaque polymer to the interlayer.

14. The method according to claim 1, wherein the additional glass sheet carries, on the face opposite the face facing the lamination interlayer, an additional stack of thin layers, particularly a low-emissivity stack comprising a transparent conductive oxide.

15. A laminated bent glazing comprising a first glass sheet coated on part of one of its faces, with the exception of a demarginated zone, with a stack of thin layers, said first glass sheet being laminated with an additional glass sheet by a lamination interlayer comprising an opaque zone, so that the opaque zone of said lamination interlayer is arranged facing the demarginated zone and the stack of thin layers is facing the lamination interlayer.

16. The method according to claim 1, wherein the laminated bent glazing is a motor vehicle windscreen or roof.

17. The method according to claim 2, wherein the at least one functional layer is an electrically conductive functional layer.

18. The method according to claim 17, wherein the electrically conductive functional layer is a silver or niobium layer, or an indium tin oxide layer, or a doped tin oxide layer or a doped zinc oxide layer.

19. The method according to claim 3, wherein the at least one phosphate is an alkaline phosphate.

20. The according to claim 5, wherein the thickness of the washable dissolving layer is between 10 and 40 μm.
